(19) United States
(12) Patent Application Publication
(10) Pub. No.: US 2005/0100257 A1
(43) Pub. Date: May 12, 2005

(54) Bearing assembly having a waterproof and dustproof sealing ring with smaller friction

(76) Inventor: Chin-Sung Oa, Taichung (TW)

Correspondence Address: Chin-Sung Oa, 58 MA YUAN WEST ST., TAICHUNG, TW

(21) Appl. No.: 10/418,979

(22) Filed: Jul. 3, 2003

Related U.S. Application Data
(63) Continuation-in-part of application No. 09/863,990, filed on May 21, 2001, now abandoned.

(51) Int. Cl. F16C 33/76

(52) U.S. Cl. 384/477

(57) ABSTRACT

A bearing assembly includes an inner race, an outer race, two opposite sealing plates, and at least one sealing ring. Thus, the sealing tip of the sealing ring is rested on the surface of the sealing plate in an elastic manner so as to decrease the friction between the sealing ring and the surface of the respective sealing plate. In addition, the sealing tip of the sealing ring can sputter the water or dust outward from the bearing assembly by action of the centrifugal force, thereby enhancing the sealing effect of the bearing assembly, so as to provide the waterproof and dustproof effects.

### CROSS-REFERENCES TO RELATED APPLICATIONS

The present invention is a continuation-in-part application of the co-pending U.S. Ser. No. 09/863,990, filed on May 21, 2001.

### BACKGROUND OF THE INVENTION

1. Field of the Invention

The present invention relates to a bearing assembly, and more particularly to a bearing assembly having a waterproof and dustproof sealing ring with smaller friction.

2. Description of the Related Art

A first conventional bearing 1 in accordance with the prior art shown in FIG. 1 is used in a yarn winding machine of a weaving factory. However, during the high speed rotation, the dyeing agent of the colorful yarn will release volatile solvent, thereby affecting operation of the conventional bearing 1. In addition, during the high speed rotation, the tiny fibers will follow the rotational air flow to enter the inside of the conventional bearing 1, thereby easily wearing the conventional bearing 1.

A second conventional bearing 100 in accordance with the prior art shown in FIG. 2 comprises sealing plates 102 (2RS type) which is mounted in a close fit. However, the sealing plates 102 are easily broken or worn out due to the large drag, thereby decreasing the sealing effect.

The U.S. Pat. No. 4,639,149 of Bras et al. disclosed a bearing assembly only having one operation waterproof line. In addition, when the bearing assembly of the Bras et al. reference is used in a horizontal manner, a water storage tank is formed between the seal plate and the outer catch wall, so that the water probably enters the inner portion of the bearing.

The U.S. Pat. No. 2,385,306 of Shafer disclosed a bearing having a labyrinth type waterproof structure that can achieve the water drain effect during operation by action of the centrifugal force. Thus, the seal plates do not contact with each other, so that the torque is small. However, when the bearing of the Shafer reference is used in a horizontal manner or disposed at a stationary state, the water enters the inner portion of the bearing through the gap formed between the two seal plates. In addition, during the high speed rotation, the dyeing agent of the colorful yarn will release volatile solvent, thereby affecting operation of the bearing. In addition, during the high speed rotation, the tiny fibers will follow the rotational air flow to enter the inside of the bearing, thereby easily wearing the bearing.

The U.S. Pat. No. 5,002,406 of Morton et al. disclosed a bearing assembly including two seal plates and a packing mounted between the two seal plates, thereby achieving a waterproof effect. However, the bearing assembly of the Morton et al. reference only has one operation waterproof line. In addition, when the bearing assembly of the Morton et al. reference is operated, a planar friction is produced between the two seal plates and the packing, thereby producing a larger torque.

### SUMMARY OF THE INVENTION

The primary objective of the present invention is to provide a bearing assembly having a sealing ring that can provide the waterproof and dustproof effects.

Another objective of the present invention is to provide a bearing assembly having a sealing ring that has smaller friction.

A further objective of the present invention is to provide a bearing assembly, wherein the sealing tip of the sealing ring is rested on the surface of the sealing plate in an elastic manner so as to decrease the friction between the sealing tip of the sealing ring and the surface of the respective sealing plate, thereby preventing the sealing tip of the sealing ring from being worn out during a long-term utilization, so as to increase the lifetime of the sealing ring.

A further objective of the present invention is to provide a bearing assembly, wherein whenever the bearing assembly is disposed at the upright or horizontal state, the sealing tip of the sealing ring can sputter the water or dust outward from the bearing assembly by action of the centrifugal force, thereby enhancing the sealing effect of the bearing assembly, so as to provide the waterproof and dustproof effects.

In accordance with the present invention, there is provided a bearing assembly, comprising an inner race, an outer race, two opposite sealing plates, and at least one sealing ring, wherein:
the outer race is, mounted on the inner race;
each of the two sealing plates is mounted between the inner race and the outer race; and
the sealing ring is mounted between the inner race and one of the two sealing plates, and is integrally formed with a mounting portion mounted on an outer wall of the inner race and a sealing portion having a periphery formed with a sealing tip rested on a surface of the respective sealing plate in an elastic manner.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a first conventional bearing in accordance with the prior art;

FIG. 2 is a partially cut-away plan cross-sectional assembly view of a second conventional bearing in accordance with the prior art;

FIG. 2A is a partially cut-away plan cross-sectional assembly view of the second conventional bearing in accordance with the prior art;

FIG. 3 is a partially cut-away plan cross-sectional assembly view of a bearing assembly in accordance with the preferred embodiment of the present invention;

FIG. 4 is a partially exploded perspective view of the bearing assembly in accordance with the preferred embodiment of the present invention;

FIG. 5 is an exploded perspective view of the bearing assembly in accordance with the preferred embodiment of the present invention;

FIG. 5A is a partially cut-away perspective cross-sectional view of the sealing ring of the bearing assembly in accordance with the preferred embodiment of the present invention;

FIG. 6 is a side plan cross-sectional assembly view of the bearing assembly as shown in FIG. 5;

FIG. 7 is an exploded perspective view of the bearing assembly in accordance with another embodiment of the present invention;

FIG. 7A is a partially cut-away perspective cross-sectional view of the sealing ring of the bearing assembly in accordance with another embodiment of the present invention;

FIG. 8 is a side plan cross-sectional assembly view of the bearing assembly as shown in FIG. 7;

FIG. 9 is a perspective assembly view of the bearing assembly in accordance with another embodiment of the present invention;

FIG. 10 is a partially cut-away perspective cross-sectional operational view of the bearing assembly in accordance with the preferred embodiment of the present invention;

FIG. 11 is a schematic plan cross-sectional operational view of the bearing assembly as shown in FIG. 10 in use; and

FIG. 12 is a partially enlarged view of the bearing assembly as shown in FIG. 11.

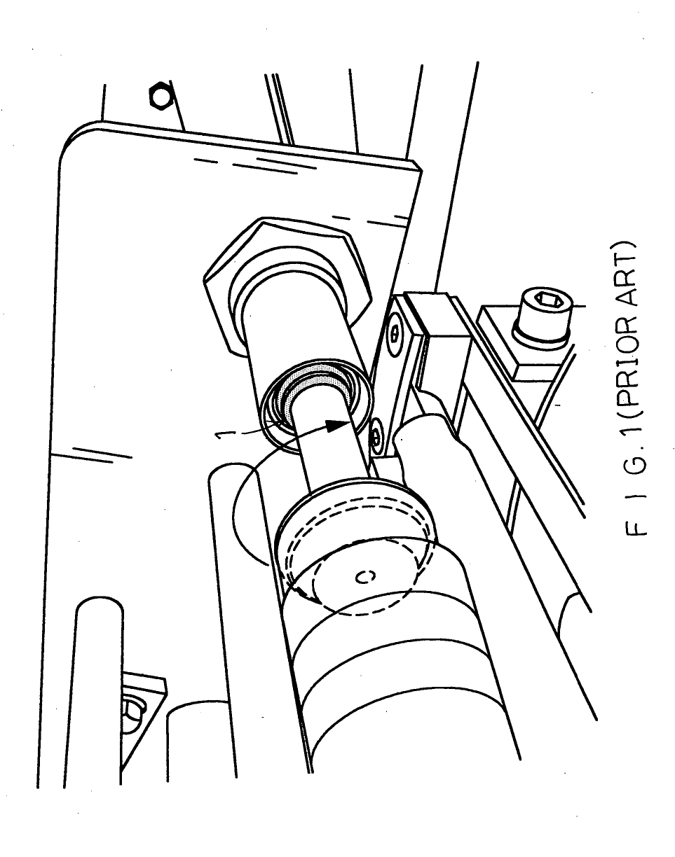

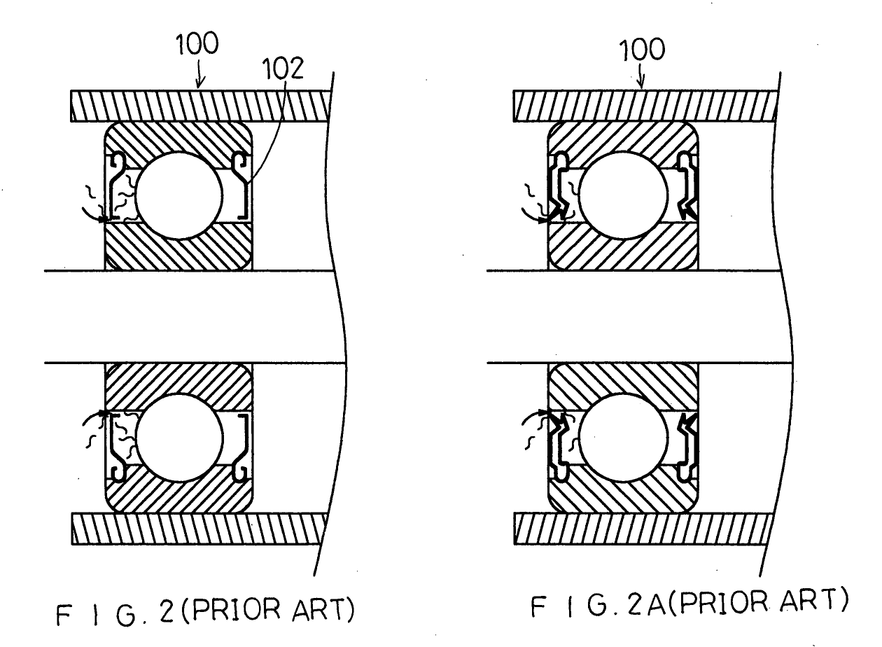

### DETAILED DESCRIPTION OF THE INVENTION

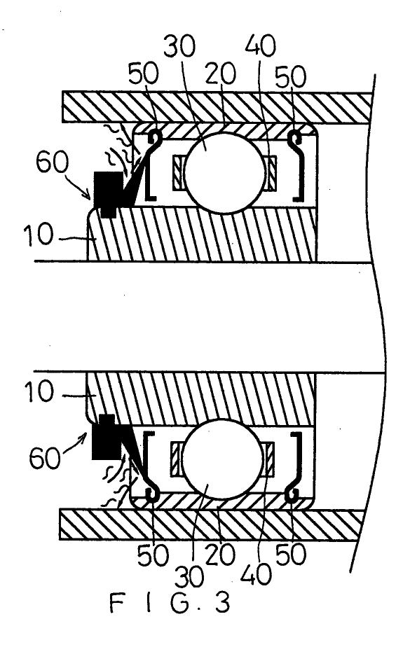

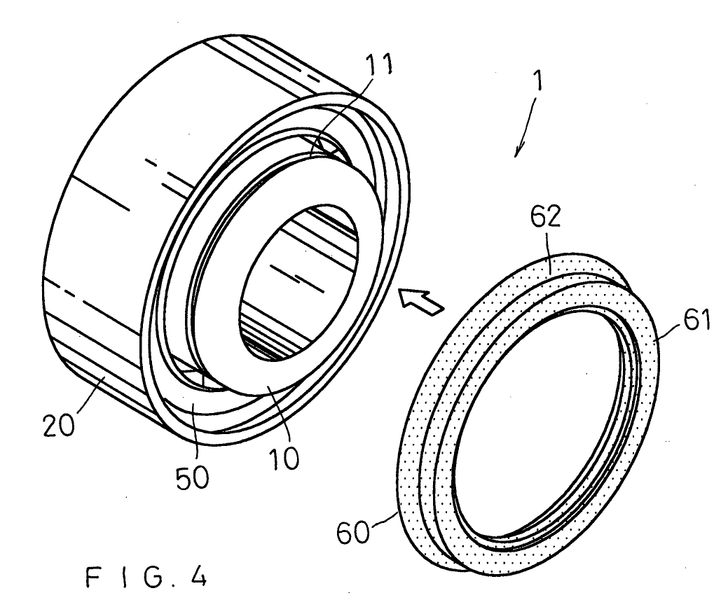

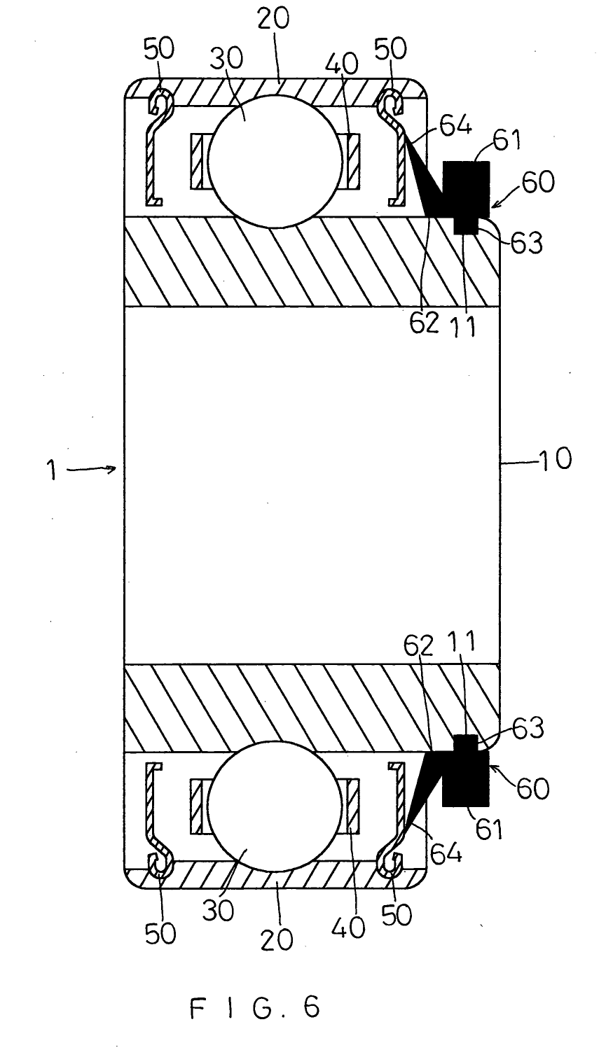

Referring to the drawings and initially to FIGS. 3-6, a bearing assembly 1 in accordance with the preferred embodiment of the present invention comprises an inner race 10, an outer race 20, two opposite sealing plates 50, and a sealing ring 60.

The inner race 10 has an outer wall formed with an annular positioning groove 11.

The outer race 20 is mounted on the inner race 10.

Each of the two sealing plates 50 is mounted between the inner race 10 and the outer race 20. Preferably, each of the two sealing plates 50 has an inner wall mounted on the outer wall of the inner race 10 in a loose fit manner, and has an outer wall mounted on an inner wall of the outer race 20 in a close fit manner. Preferably, each of the two sealing plates 50 is made of ferrite material or rubber material.

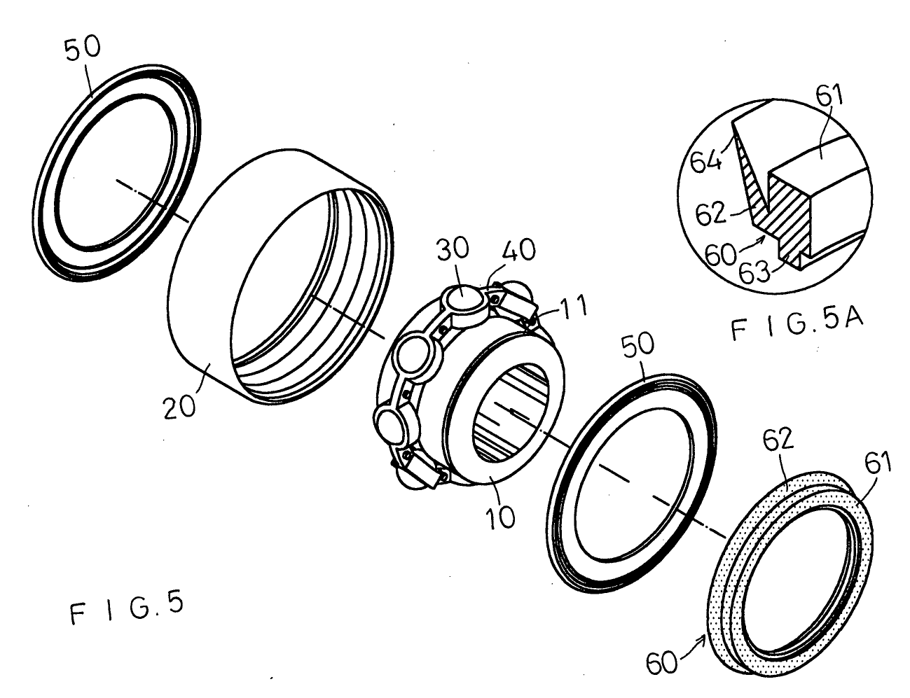

As shown in FIGS. 5 and 5A, the sealing ring 60 is mounted on one side of the inner race 10 of the bearing assembly 1. Preferably, the sealing ring 60 is made of rubber material. The sealing ring 60 is mounted between the inner race 10 and one of the two sealing plates 50. The sealing ring 60 is integrally formed with a mounting portion 61 mounted on the outer wall of the inner race 10 and a sealing portion 62 juxtaposed to the mounting portion 61 and located adjacent to the respective sealing plate 50. The mounting portion 61 of the sealing ring 60 has an inner wall formed with an annular positioning flange 63 secured in the positioning groove 11 of the inner race 10. The sealing portion 62 of the sealing ring 60 has a tapered shape, and has a periphery formed with a sealing tip 64 rested on a surface of the respective sealing plate 50 in an elastic manner. In such a manner, the sealing tip 64 of the sealing portion 62 of the sealing ring 60 can prevent water or dust from entering the gap defined between the inner race 10 and the respective sealing plate 50, so as to provide the waterproof and dustproof effects.

In such a manner, the sealing plate 50 is fixed on the outer race 20, and the sealing ring 60 is fixed on the inner race 10 to rotate therewith.

The bearing assembly 1 further comprises a retainer 40 mounted on the outer wall of the inner race 10, and a plurality of rolling balls 30 mounted on the retainer 40 and rotatably mounted in the outer race 20.

In practice, the sealing tip 64 of the sealing portion 62 of the sealing ring 60 is in contact with the surface of the respective sealing plate 50 in the following manners, including zero-contact, line contact and planar contact.

In the first manner, the contact point of the sealing tip 64 of the sealing portion 62 of the sealing ring 60 with the surface of the respective sealing plate 50 is maintained at a range between 0.1 mm and 0.5 mm. In such a manner, the bearing assembly 1 is used at the environment without pollution under the inoperative condition. Thus, the bearing assembly 1 will not increase the torque, and can prevent the pollution and dust. For example, the bearing assembly 1 is available for the carbon brush motor. Thus, there is no contact, so that the friction face does not have the problem of the friction heat.

In the second manner, the sealing tip 64 of the sealing portion 62 of the sealing ring 60 is in contact with the surface of the respective sealing plate 50 in the line contact manner. In such a manner, the bearing assembly 1 is operated at a high speed and can prevent the pollution and dust. In addition, the sealing tip 64 of the sealing portion 62 of the sealing ring 60 can produce a centrifugal air flow at the high speed can also provide a heatsink effect to reduce the temperature. For example, the bearing assembly 1 is available for the pneumatic tool and the weaving machine.

In the third manner, the sealing tip 64 of the sealing portion 62 of the sealing ring 60 is in contact with the surface of the respective sealing plate 50 in the planar contact manner. In such a manner, the sealing tip 64 of the sealing portion 62 of the sealing ring 60 and the surface of the respective sealing plate 50 have a larger contact area, thereby enhancing the protective effect of the bearing assembly 1. In addition, the sealing tip 64 of the sealing portion 62 of the sealing ring 60 is rested on the surface of the respective sealing plate 50 in an elastic manner, to decrease the friction between the sealing tip 64 of the sealing portion 62 of the sealing ring 60 and the surface of the respective sealing plate 50, thereby preventing the sealing tip 64 of the sealing portion 62 of the sealing ring 60 from being worn out during a long-term utilization, so as to increase the lifetime of the sealing ring 60.

Thus, the friction of the a bearing assembly 1 is determined by the contact relationship (including zero-contact, line contact and planar contact) between the sealing tip 64 of the sealing portion 62 of the sealing ring 60 and the surface of the respective sealing plate, so that the a bearing assembly 1 is available for different environments of operation.

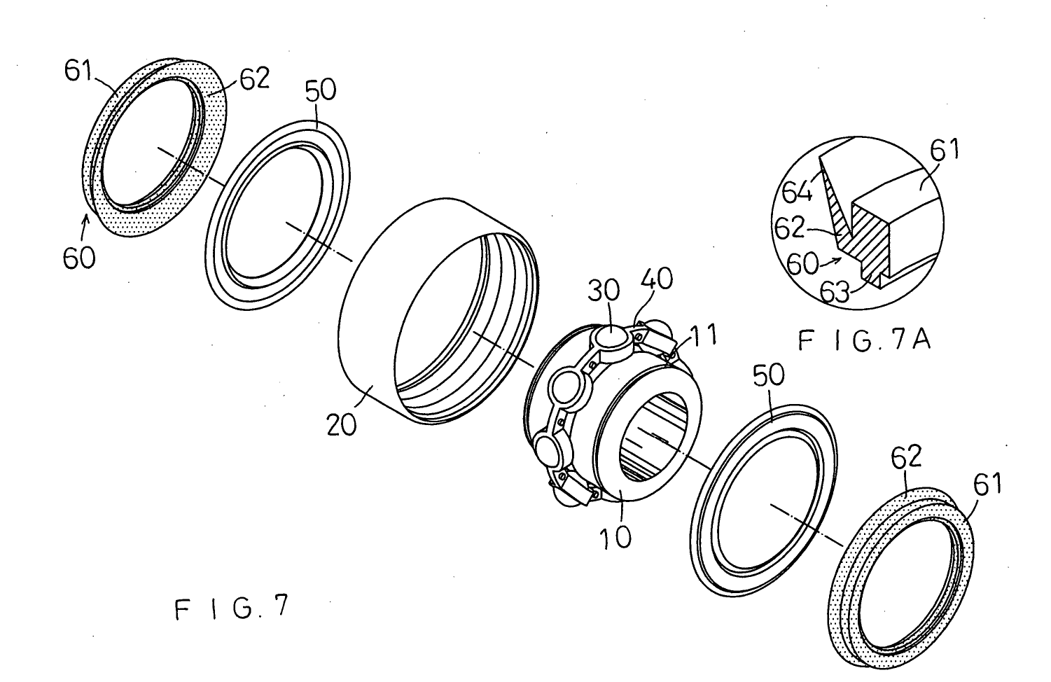

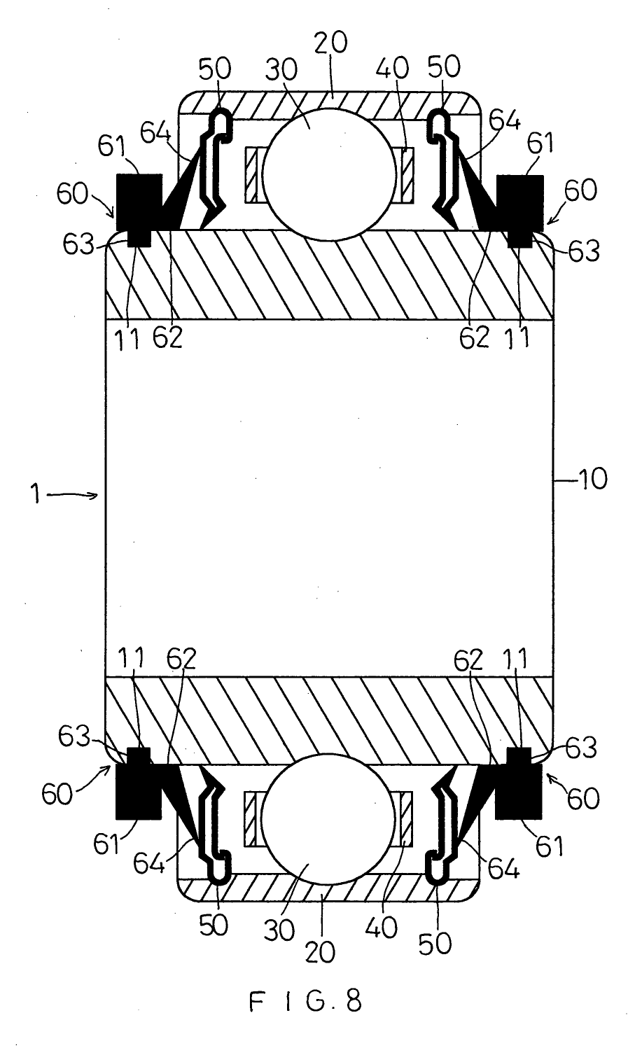

Referring to FIGS. 7, 7A and 8, in accordance with another embodiment of the present invention, the, bearing assembly 1 comprises two opposite sealing rings 60 mounted on the two sides of the inner race 10.

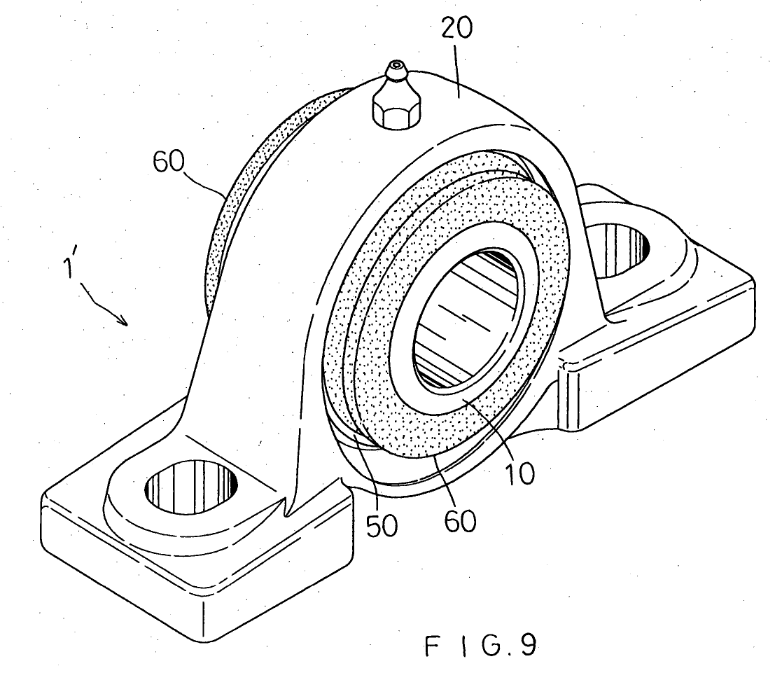

Referring to FIG. 9, in accordance with another embodiment of the present invention, the bearing assembly 1′ comprises two opposite sealing rings 60 mounted on the two sides of the inner race 10.

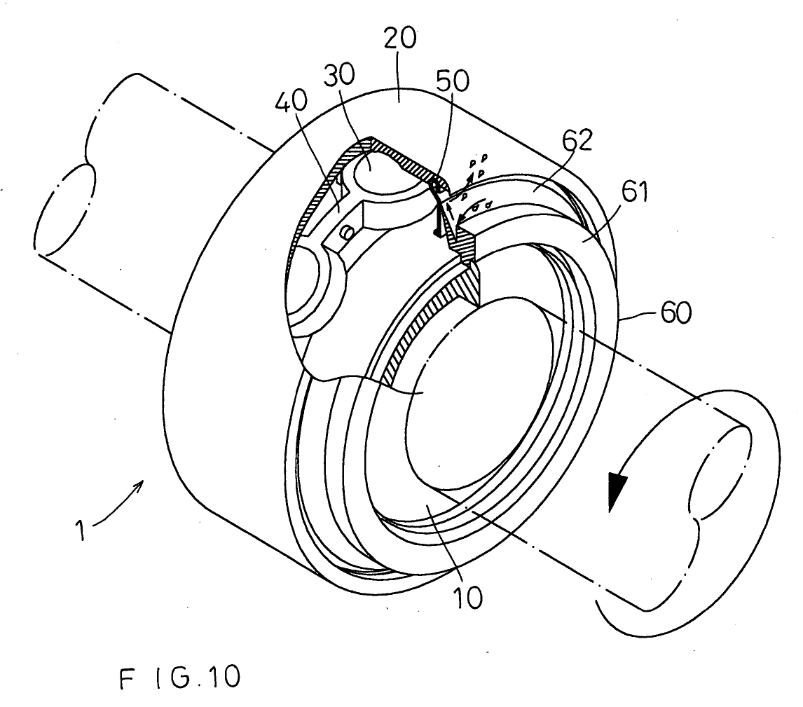

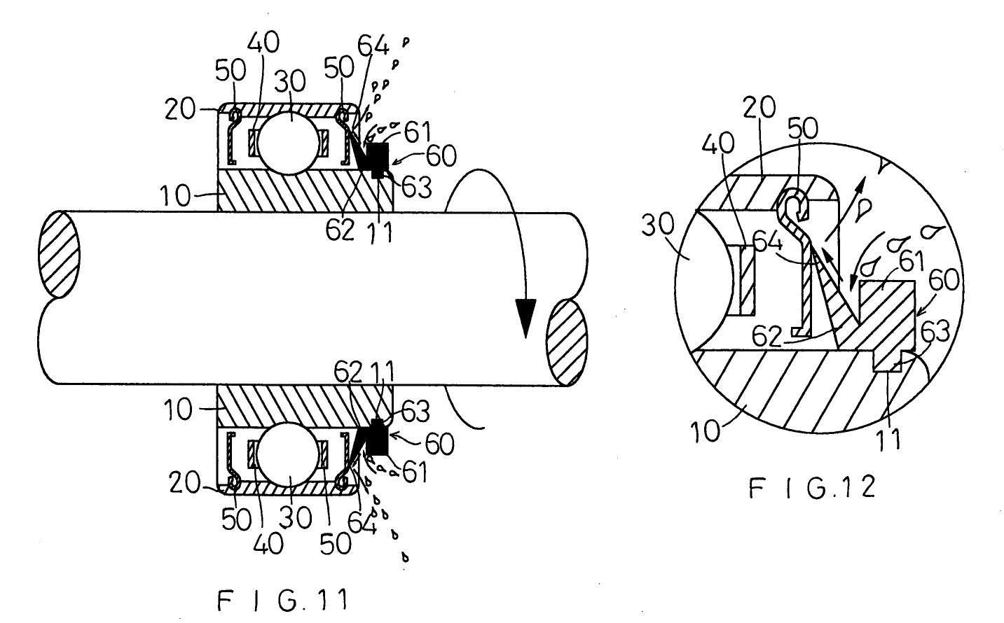

In operation, referring to FIGS. 10-12, during operation of the bearing assembly 1, the sealing tip 64 of the sealing portion 62 of the sealing ring 60 can sputter the water outward from the bearing assembly 1 by action of the centrifugal force, thereby enhancing the sealing effect of the bearing assembly 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A bearing assembly, comprising an inner race, an outer race, two opposite sealing plates, and at least one sealing ring, wherein:
the outer race is mounted on the inner race,
each of the two sealing plates is mounted between the inner race and the outer race; and
the sealing ring is mounted between the inner race and one of the two sealing plates, and is integrally formed with a mounting portion mounted on an outer wall of the inner race and a sealing portion having a periphery formed with a sealing tip rested on a surface of the respective sealing plate in an elastic manner.

2. The bearing assembly in accordance with claim 1, wherein the bearing assembly is disposed at an upright state.

3. The bearing assembly in accordance with claim 1, wherein the bearing assembly is disposed at a horizontal state.

4. The bearing assembly in accordance with claim 1, wherein the each of the two sealing plates has an inner wall mounted on the outer wall of the inner race in a loose fit manner.

5. The bearing assembly in accordance with claim 1, wherein the each of the two sealing plates has an outer wall mounted on an inner wall of the outer race in a close fit manner.

6. The bearing assembly in accordance with claim 1, wherein the sealing ring is mounted on-one side of the inner race of the bearing assembly.

7. The bearing assembly in accordance with claim 1, wherein the bearing assembly comprises two opposite sealing rings mounted on two sides of the inner race.

8. The bearing assembly in accordance with claim 1, wherein the sealing ring is made of rubber material.

9. The bearing assembly in accordance with claim 1, wherein the outer wall of the inner race is formed with an annular positioning groove, and the mounting portion of the sealing ring has an inner wall formed with an annular positioning flange secured in the positioning groove of the inner race.

10. The bearing assembly in accordance with claim 1, wherein the sealing portion of the sealing ring is juxtaposed to the mounting portion and located adjacent to the respective sealing plate.

11. The bearing assembly in accordance with claim 1, wherein the sealing portion of the sealing ring has a tapered shape.

12. The bearing assembly in accordance with claim 1, further comprising a retainer mounted on the outer wall of the inner race, and a plurality of rolling balls mounted on the retainer and rotatably mounted in the outer race.

13. The bearing assembly in accordance with claim 1, wherein the sealing tip of the sealing portion of the sealing ring and the surface of the respective sealing plate form a zero-contact, and the contact point of the sealing tip of the sealing portion of the sealing ring with the surface of the respective sealing plate is maintained at a range between 0.1 mm and 0.5 mm.

14. The bearing assembly in accordance with claim 1, wherein the sealing tip of the sealing portion of the sealing ring and the surface of the respective sealing plate form a line contact.

15. The bearing assembly in accordance with claim 1, wherein the sealing tip of the sealing portion of the sealing ring and the surface of the respective sealing plate form a planar contact.
